(19) United States
(12) Patent Application Publication
(10) Pub. No.: US 2016/0124090 A1
(43) Pub. Date: May 5, 2016

(54) Range Finder

(71) Applicants: Sintai Optical (Shenzhen) Co., Ltd., Shenzhen City (CN); Asia Optical International Ltd., Tortola (GB)

(72) Inventors: Hua-Tang Liu, Taichung (TW); Hui-Qing Chen, Shenzhen City (CN); Lian Zhao, Shenzhen City (CN); Chin-Hsiang Wang, Taichung (TW)

(21) Appl. No.: 14/922,261

(22) Filed: Oct. 26, 2015

(30) Foreign Application Priority Data
Nov. 3, 2014 (CN) 201410614411.X

(51) Int. Cl. G01S 17/08; H04N 5/33; H04N 7/18; G01S 17/02; G01S 17/89

(52) U.S. Cl. CPC G01S 17/08; G01S 17/023; G01S 17/89; H04N 7/183; H04N 5/33

(57) ABSTRACT

A range finder includes a laser transmitter, a laser receiver, an objective lens, an image sensing device, a display device and a microphone. The laser transmitter is configured to emit a laser beam to a measured object. The laser receiver is configured to receive a reflected laser beam reflected by the measured object. The objective lens is configured to allow visible light reflected by the measured object to pass therethrough. The image sensing device is configured to receive the visible light passing through the objective lens and generate an image signal. The display device is configured to receive the image signal and display an image of the measured object. The microphone is configured to record sound.

### BACKGROUND OF THE INVENTION

1. Field of the Invention

The invention relates to a range finder, and more particularly to a range finder with night vision function capable of operating at night or in an environment of insufficient light.

2. Description of the Related Art

Referring to FIG. 1, a range finder 10 capable of measuring a distance at night is shown. The range finder 10 is provided with a displaying system which includes a display device 17 and an eyepiece 18. The range finder 10 is further provided with an emitting-and-receiving system which includes a laser transmitter 12, a second collimating lens 21, an objective lens 13, a prism 14 and a laser receiver 19. The laser transmitter 12 emits a laser beam 12T to a measured object (not shown). The laser beam 12T is reflected by the measured object to become a reflected laser beam 12R. The reflected laser beam 12R is reflected toward the range finder 10 and received by the laser receiver 19. The range finder 10 is further provided with an image sensing system which includes the objective lens 13, the prism 14, a focusing lens 15 and an image sensing device 16 to capture an image of the measured object when the environment is well-lit. The range finder 10 is further provided with a night vision system which includes an infrared ray transmitter 11, a first collimating lens 20, the objective lens 13, the prism 14, the focusing lens 15 and the image sensing device 16 to capture an image of the measured object at night or in an environment of insufficient light. In operation, the infrared ray transmitter 11 emits infrared ray 11T to the measured object, and the infrared ray 11T is reflected by the measured object to become reflected infrared ray 11R. The reflected infrared ray 11R is reflected toward the range finder 10 and received by the image sensing device 16. The image sensing device 16 converts the received infrared ray into image signals. The image signals are transmitted to and displayed by the display device 17.

The prism 14 and the infrared ray transmitter 11 provide the night vision function for the range finder 10. However, the prism 14 and the infrared ray transmitter 11 increase the manufacturing cost. Further, the reflected visible light V10 and the reflected infrared ray 11R decay after passing through the prism 14, which reduces intensity of the visible light and infrared ray captured by the image sensing device 16 and thus affects the operation of the range finder.

### BRIEF SUMMARY OF THE INVENTION

An object of the invention is to provide a range finder utilizing an objective lens with a large aperture and an image sensing device with high sensitivity to collect and receive a great amount of light, whereby the range finder of the invention is provided with night vision function even without the prism and the infrared ray transmitter used in the conventional range finder.

The range finder in accordance with an exemplary embodiment of the invention includes a laser transmitter, a laser receiver, an objective lens, an image sensing device, a display device and a microphone. The laser transmitter is configured to emit a laser beam to a measured object. The laser receiver is configured to receive a reflected laser beam reflected by the measured object. The objective lens is configured to allow visible light reflected by the measured object to pass therethrough. The image sensing device is configured to receive the visible light passing through the objective lens and generate an image signal. The display device is configured to receive the image signal and display an image of the measured object. The microphone is configured to record sound.

In another exemplary embodiment, the range finder further includes a collimating lens disposed between the laser transmitter and the measured object.

In yet another exemplary embodiment, the range finder further includes a collective lens disposed between the laser receiver and the measured object.

In another exemplary embodiment, the range finder further includes a focusing lens disposed between the objective lens and the image sensing device.

In yet another exemplary embodiment, the range finder further includes an eyepiece disposed near the display device for observing the display device.

In another exemplary embodiment, the laser transmitter includes a semiconductor laser.

In yet another exemplary embodiment, the laser receiver includes an avalanche photodiode or a photodiode.

In another exemplary embodiment, the laser receiver includes an avalanche photodiode or a photodiode.

In yet another exemplary embodiment, the display device includes a liquid crystal display, an organic liquid crystal display or an active-matrix organic light emitting diode display.

In another exemplary embodiment, the image sensing device includes a charge coupled device or a complementary metal-oxide-semiconductor image sensing element.

In yet another exemplary embodiment, the range finder further includes a filter disposed between the collective lens and the laser receiver to allow only the reflected laser beam to pass.

In another exemplary embodiment, the reflected laser beam does not pass through the objective lens.

In yet another exemplary embodiment, the range finder includes a laser transmitter, a laser receiver, an objective lens, an image sensing device, and a display device. The laser transmitter is configured to emit a laser beam to a measured object. The laser receiver is configured to receive a reflected laser beam reflected by the measured object. The objective lens is configured to allow visible light reflected by the measured object to pass therethrough. The image sensing device is configured to receive the visible light passing through the objective lens and generate an image signal. The display device is configured to receive the image signal and display an image of the measured object. The reflected laser beam does not pass through the objective lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts a conventional range finder with night vision function; and

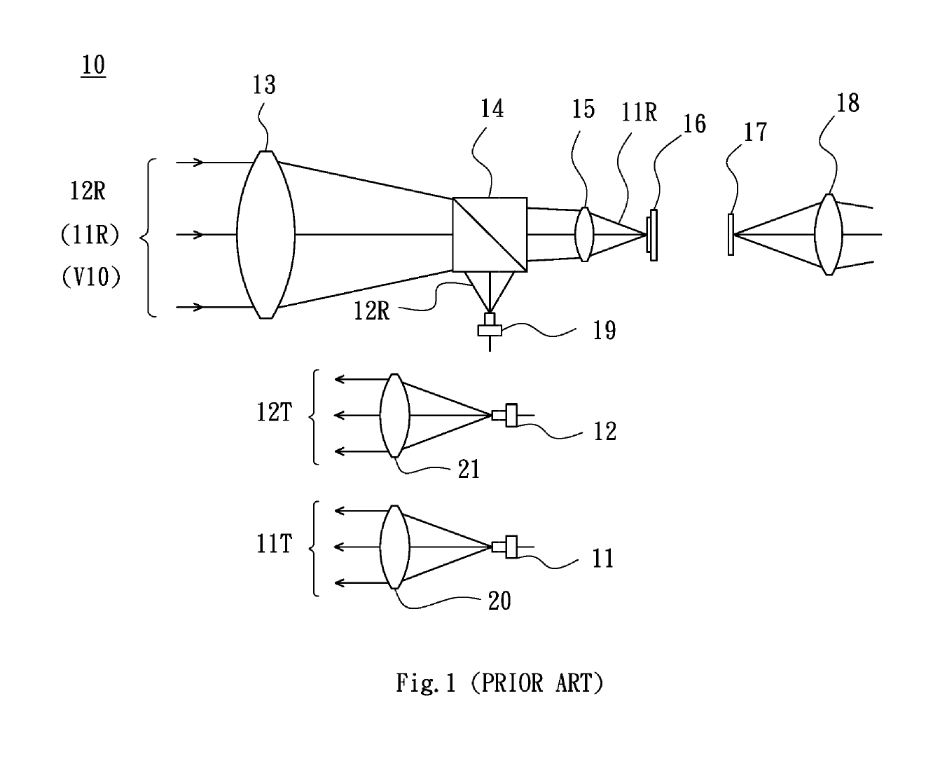

FIG. 2 depicts a range finder in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

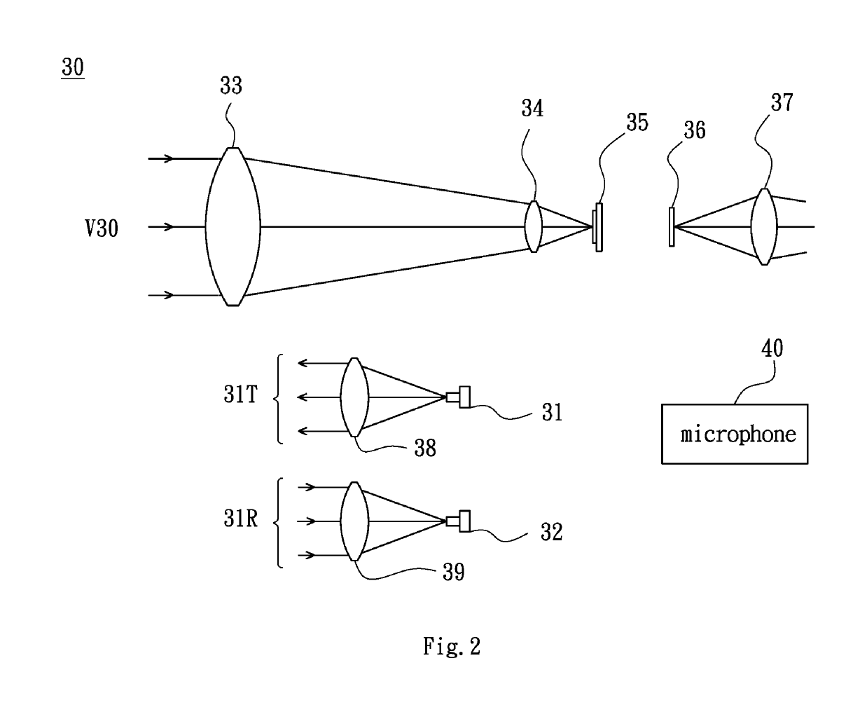

Referring to FIG. 2, a range finder 30 of the invention includes a laser transmitter 31, a laser receiver 32, an objective lens 33, a focusing lens 34, an image sensing device 35, a display device 36, an eyepiece 37, a collimating lens 38, a concentrate lens 39 and a microphone 40.

The laser transmitter 31, the collimating lens 38, the laser receiver 32 and the conservation lens 39 constitute a laser transmitting and receiving system of the range finder 30. The objective lens 33, the focusing lens 34 and the image sensing device 35 constitute an image capturing system of the range finder 30. The display device 36 and the eyepiece 37 constitute a distance measuring system of the range finder 30.

When the range finder 30 is disposed toward a measured region (not shown), visible light V30 from the measured region enters the range finder 30 and is received by the image sensing device 35 to generate an image. The image is transmitted to and displayed by the display device 36 for observation by a user. The user is able to aim the range finder 30 at a measured object (not shown) in the measured region through observing the image. The laser transmitting and receiving system emits a laser beam 31T to the measured object and receives a reflected laser beam 31R reflected by the measured object, whereby a distance from the measured object to the range finder 30 is calculated and displayed by the display device 36. The microphone 40 is configured to record environmental sound.

Referring to FIG. 2 again, when the range finder 30 is disposed toward the measured region (not shown), visible light V30 from the measured region is received by the range finder 30. The visible light V30 passes through the objective lens 33 and the focusing lens 34 and finally reaches the image sensing device 35. The image sensing device 35 converts the visible light V30 into an image signal. The image signal is transmitted to and displayed by the display device 36. The image displayed by the display device 36 is observed by a user through the eyepiece 37.

When the range finder 30 is aimed at the measured object in the measured region, the laser transmitter 31 emits a laser beam 31T. The laser beam 31T passes through the collimating lens 38 to become a collimated laser beam 31T, and the collimated laser beam 31T travels to reach the measured object and is reflected by the measured object to become a reflected laser beam 31R. The reflected laser beam 31R is received by the range finder 30. The received reflected laser beam 31R passes through the collective lens 39 and afterwards enters the laser receiver 32. The laser receiver 32 receives the reflected laser beam 31R to calculate a distance between the measured object and the range finder 30. The calculated distance value is displayed by the display device 36 and observed by a user through the eyepiece 37.

In the above embodiment, the reflected laser beam 31R directly enters the laser receiver 32. It is understood that a filter can be disposed between the collective lens 39 and the laser receiver 32 allowing only the reflected laser beam 31R to pass therethrough, which also belongs to the category of the invention.

In some embodiments, the laser transmitter 31 is a semiconductor laser. The laser receiver 32 is an avalanche photodiode or a photodiode. The image sensing device 35 is a charge coupled device or a complementary metal-oxide-semiconductor image sensing element. The display device 36 is a liquid crystal display, an organic liquid crystal display or an active-matrix organic light emitting diode display.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A range finder, comprising:
a laser transmitter configured to emit a laser beam to a measured object;
a laser receiver configured to receive a reflected laser beam reflected by the measured object;
an objective lens configured to allow visible light reflected by the measured object to pass therethrough;
an image sensing device configured to receive the visible light passing through the objective lens and generate an image signal;
a display device configured to receive the image signal and display an image of the measured object; and
a microphone configured to record sound.

2. The range finder as claimed in claim 1, further comprising a collimating lens disposed between the laser transmitter and the measured object.

3. The range finder as claimed in claim 1, further comprising a collective lens disposed between the laser receiver and the measured object.

4. The range finder as claimed in claim 1, further comprising a focusing lens disposed between the objective lens and the image sensing device.

5. The range finder as claimed in claim 1, further comprising an eyepiece disposed near the display device for observing the display device.

6. The range finder as claimed in claim 1, wherein the laser transmitter comprises a semiconductor laser.

7. The range finder as claimed in claim 1, wherein the laser receiver comprises an avalanche photodiode or a photodiode.

8. The range finder as claimed in claim 1, wherein the display device comprises a liquid crystal display, an organic liquid crystal display or an active-matrix organic light emitting diode display.

9. The range finder as claimed in claim 1, wherein the image sensing device comprises a charge coupled device or a complementary metal-oxide-semiconductor image sensing element.

10. The range finder as claimed in claim 3, further comprising a filter disposed between the collective lens and the laser receiver to allow only the reflected laser beam to pass.

11. The range finder as claimed in claim 1, wherein the reflected laser beam does not pass through the objective lens.

12. A range finder, comprising:
a laser transmitter configured to emit a laser beam to a measured object;
a laser receiver configured to receive a reflected laser beam reflected by the measured object;
an objective lens configured to allow visible light reflected by the measured object to pass therethrough;
an image sensing device configured to receive the visible light passing through the objective lens and generate an image signal; and
a display device configured to receive the image signal and display an image of the measured object;
wherein the reflected laser beam does not pass through the objective lens.
